(19) United States
(12) Patent Application Publication
(10) Pub. No.: US 2024/0269744 A1
(43) Pub. Date: Aug. 15, 2024

(54) JOINED BODY AND MANUFACTURING METHOD THEREOF

(71) Applicants: NGK INSULATORS, LTD., Nagoya-City (JP); OKUMA CORPORATION, Niwa-Gun (JP)

(72) Inventors: Takahiro ISHIKAWA, Toyoake-City (JP); Masato YASUDA, Obu-City (JP); Toshiaki ISHIHARA, Nagoya-City (JP); Seiei YAMAMOTO, Niwa-Gun (JP); Kazuhide GOTO, Niwa-Gun (JP); Makoto SUZUKI, Niwa-Gun (JP)

(73) Assignees: NGK INSULATORS, LTD., Nagoya-City (JP); OKUMA CORPORATION, Niwa-Gun (JP)

(21) Appl. No.: 18/644,302

(22) Filed: Apr. 24, 2024

Related U.S. Application Data
(63) Continuation of application No. PCT/JP2022/040930, filed on Nov. 1, 2022.

(30) Foreign Application Priority Data
Nov. 5, 2021 (JP) 2021-181272

(51) Int. Cl. B22F 10/25; B33Y 10/00; B33Y 70/00; B33Y 80/00

(52) U.S. Cl. CPC B22F 10/25; B33Y 10/00; B22F 2202/11; B22F 2203/11; B22F 2301/15; B22F 2301/35; B22F 2303/40; B33Y 70/00; B33Y 80/00

(57) ABSTRACT

Provided is a bonded body of copper alloy and steel material that has high bonding property at the interface of the copper alloy and the steel material, and is capable of maintaining a high strength without carrying out the subsequent precipitation hardening process accompanied by solution annealing (or by carrying out only the precipitation hardening process that is not accompanied by the solution annealing). This bonded body includes a first member composed of a precipitation-hardenable copper alloy and a second member including an additively manufactured object made of a steel material bonded to the first member at at least one bonding interface. The bonded body, when the cross section perpendicular to the bonding interface is observed by a scanning electron microscope (SEM), is free of voids having a length of 50 μm or more at the bonding interface in a direction parallel to the bonding interface.

### CROSS-REFERENCE TO RELATED APPLICATIONS

This application is a continuation application of PCT/JP2022/040930 filed Nov. 1, 2022, which claims priority to Japanese Patent Application No. 2021-181272 filed Nov. 5, 2021, the entire contents all of which are incorporated herein by reference.

### BACKGROUND OF THE INVENTION

### 1. Field of the Invention

The present invention relates to a bonded body of a copper alloy and a steel material, and a method for manufacturing the same.

### 2. Description of the Related Art

Previously known types of molds include molds for plastic to carry out injection molding and the like (e.g., a mold insert) and die casting molds to process an aluminum alloy and the like (e.g., chill vent for gas exhaust), and there are other various molds such as die casting faucet parts. When taking molds for plastic as an example, car interior and exterior parts such as doors and spoilers, and automotive functional parts such as intake manifold and ECU case are manufactured using molds. Since automotive functional parts particularly have intricate formes, parts materials require to be quickly cooled when molded in a mold. In this aspect, copper is known as a material having a high heat conductivity property, and thus a copper alloy can be considered to be used as a mold.

Additionally, in the application that locally requires a higher strength than a copper alloy, the bonding of a copper alloy and a steel material has been practiced. For example, Patent Literature 1 (JP2019-123118A) discloses a mold for injection molding provided with a gas vent hole that exhausts a gas at a confluence of molten resins filling a cavity between a movable mold and a stationary mold, wherein the gas vent hole is formed by diffusion bonding of a steel material and a copper alloy material (a base member and a spacer member). It is considered that such a composition can enhance the heat conductivity property by the copper alloy material while ensuring the required strength by the steel material.

### CITATION LIST

### Patent Literature

Patent Literature 1: JP2019-123118A

### SUMMARY OF THE INVENTION

Materials for automotive functional parts often include engineering plastics and glass fibers for weight reduction and strength enhancement. When these materials are molded using a mold made of a copper alloy, the copper alloy wears due to a hard glass fiber. When a mold on which a copper alloy is coated is used, the copper alloy detaches due to molding. To the contrary, when a mold made of a steel material inside of which a copper alloy is bonded is used, the issues of wearing and detachment of a copper alloy can be considered to be solved while quickly cooling the materials.

For bonding a steel material and a copper alloy, methods of thermal spraying and welding have been used, however, a copper alloy has a low softening point, and a copper alloy and a steel material have different degrees of the thermal contraction, whereby voids and solidification cracking likely occur at the bonding interface, thereby causing insufficient bonding. Additionally, it is desirable to use a precipitation-hardenable copper alloy, which is a copper alloy having a comparatively high strength as a mold, however, such a copper alloy, when used, has a softening point as low as from 300 to 500° C., thereby causing the copper alloy to soften due to heat input during bonding to a steel material. This softening can be recovered by solution annealing and the subsequent precipitation hardening process, but the solution annealing requires heat treatment in a high temperature range from 700 to 1000° C. For this reason, voids and the like at the bonding interface spread, thereby inducing early detachment of the steel material. This also applies to the diffusion bonding method as employed in Patent Literature 1. As just described, the bonding of the precipitation-hardenable copper alloy and a steel material has posed issues in 2 viewpoints of bonding reduction and strength reduction.

The present inventors have recently found that by forming an additively manufactured object made of a steel material by laser metal deposition (LMD) onto a precipitation-hardenable copper alloy, it is possible to provide a bonded body of copper alloy and steel material that has high bonding property at the interface of the copper alloy and the steel material, and is capable of maintaining a high strength even without carrying out the subsequent precipitation hardening process accompanied by the solution annealing (or by carrying out only the precipitation hardening process that is not accompanied by the solution annealing).

Consequently, an object of the present invention is to provide a bonded body of copper alloy and steel material that has high bonding property at the interface of the copper alloy and the steel material, and is capable of maintaining a high strength even without carrying out the subsequent precipitation hardening process accompanied by solution annealing (or by carrying out only the precipitation hardening process that is not accompanied by the solution annealing), and a method for manufacturing the same.

The present invention provides the following aspects.

### Aspect 1

A bonded body comprising a first member composed of a precipitation-hardenable copper alloy and a second member including an additively manufactured object made of a steel material bonded to the first member at at least one bonding interface, wherein the bonded body, when a cross section perpendicular to the bonding interface is observed by a scanning electron microscope (SEM), is free of voids having a length of 50 μm or more at the bonding interface in a direction parallel to the bonding interface.

### Aspect 2

The bonded body according to aspect 1, wherein the additively manufactured object made of a steel material is formed by laser metal deposition (LMD).

### Aspect 3

The bonded body according to aspect 1 or 2, wherein the first member has a Vickers hardness of HV 200 or more at a main part wherein a part within 1.0 mm from the bonding interface in a thickness direction is excluded.

### Aspect 4

The bonded body according to any one of aspects 1 to 3, wherein the first member has a Vickers hardness of HV 200 or more throughout the entirety including a part within 1.0 mm from the bonding interface in a thickness direction and a main part other than the part within 1.0 the bonding interface.

### Aspect 5

The bonded body according to any one of aspects 1 to 4, wherein the steel material of the second member has a Vickers hardness of HV 300 or more at a main part wherein a part within 1.0 mm from the bonding interface in a thickness direction is excluded.

### Aspect 6

The bonded body according to any one of aspects 1 to 5, wherein the precipitation-hardenable copper alloy is at least one alloy selected from the group consisting of chromium copper alloys, chromium zirconium copper alloys, titanium copper alloys, nickel silicon copper alloys, nickel tin copper alloys, and beryllium copper alloys.

### Aspect 7

The bonded body according to aspect 6, wherein the precipitation-hardenable copper alloy is a beryllium copper alloy.

### Aspect 8

The bonded body according to any one of aspects 1 to 7, wherein the steel material is composed of at least one steel selected from the group consisting of die steel (SKD), high speed tool steel (SKH), stainless steel (SUS), and maraging steel.

### Aspect 9

The bonded body according to any one of aspects 1 to 8, wherein the second member is further provided with a middle layer composed of a heterogeneous metal material on a surface contacting the first member.

### Aspect 10

The bonded body according to aspect 9, wherein the heterogeneous metal material composing a middle layer is an alloy comprising Ni as a main component.

### Aspect 11

The bonded body according to aspect 9 or 10, wherein the heterogeneous metal material composing a middle layer is a nickel-chromium-iron alloy comprising Ni as a main component.

### Aspect 12

The bonded body according to any one of aspects 9 to 11, wherein the bonded body, when a cross section perpendicular to the bonding interface is observed by a scanning electron microscope (SEM), is free of voids having a length of 10 μm or more at the bonding interface in a direction parallel to the bonding interface.

### Aspect 13

The bonded body according to any one of aspects 2 to 12, wherein the precipitation-hardenable copper alloy of the first member has a heat conductivity of 160 W/mK or more after precipitation hardening process.

### Aspect 14

The bonded body according to aspect 13, wherein the precipitation-hardenable copper alloy is at least one alloy selected from the group consisting of chromium copper alloys, chromium zirconium copper alloys, nickel silicon copper alloys, and beryllium copper alloys.

### Aspect 15

An article comprising the bonded body according to any one of aspects 1 to 14, wherein the article is selected from a mold and a mold component.

### Aspect 16

A method for manufacturing the bonded body any one of aspects 1 to 14, comprising the steps of:
providing a first member composed of a precipitation-hardenable copper alloy which has been subjected to solution annealing, or solution annealing and aging treatment, and
forming, as a second member, an additively manufactured object composed of a steel material by laser metal deposition (LMD) using a powder of the steel material on or above a surface of the first member to obtain a bonded body.

### Aspect 17

The method according to aspect 16, further comprising the step of, prior to forming the additively manufactured object composed of a steel material, forming a middle layer on the surface of the first member by LMD using a powder of an alloy comprising a heterogeneous metal other than Cu and Fe as the main component, and
wherein the formation of the additively manufactured object composed of the steel material by the LMD using a powder of the steel material is performed on a surface of the middle layer.

### Aspect 18

The method according to aspect 16 or 17, wherein the precipitation-hardenable copper alloy has a heat conductivity of 160 W/mK or more after precipitation hardening process,
wherein the precipitation-hardenable copper alloy composing the first member, before forming the second member, has been subjected to solution annealing so as to have a heat conductivity of less than 160 W/mK, and
wherein the precipitation-hardenable copper alloy composing the first member, after forming the second member, is subjected to precipitation hardening process so that a heat conductivity of the precipitation-hardenable copper alloy is adjusted to be 160 W/mK or more.

### Aspect 19

The method according to any one of aspects 16 to 18, further comprising the step of, after forming the additively manufactured object, retaining the bonded body at a temperature from 280 to 530° C. for from 30 minutes to 5 hours to carry out the precipitation hardening process.

### Aspect 20

The method according to any one of aspects 16 to 19, wherein, during and after the LMD, the first member is not retained at a temperature of 400° C. or more for 10 minutes or more, and the first member is not retained at a temperature of 500° C. or more for 3 minutes or more.

### Aspect 21

The method according to any one of aspects 16 to 20, wherein the precipitation-hardenable copper alloy is at least one alloy selected from the group consisting of chromium copper alloys, chromium zirconium copper alloys, titanium copper alloys, nickel silicon copper alloys, nickel tin copper alloys, and beryllium copper alloys.

### Aspect 22

The method according to aspect 18, wherein the precipitation-hardenable copper alloy is at least one alloy selected from the group consisting of chromium copper alloys, chromium zirconium copper alloys, nickel silicon copper alloys, and beryllium copper alloys.

### Aspect 23

The method according to any one of aspects 16 to 22, wherein the precipitation-hardenable copper alloy is a beryllium copper alloy.

### Aspect 24

The method according to any one of aspects 16 to 23, wherein the steel material is composed of at least one steel selected from the group consisting of die steel (SKD), high speed tool steel (SKH), stainless steel (SUS), and maraging steel.

### Aspect 25

The method according to any one of aspects 17 to 24, wherein the heterogeneous metal material composing a middle layer is an alloy comprising Ni as a main component.

### Aspect 26

The method according to any one of aspects 17 to 25, wherein the heterogeneous metal material composing a middle layer is a nickel-chromium-iron alloy comprising Ni as a main component.

### BRIEF DESCRIPTION OF THE DRAWINGS

FIG. 1A is an optical microscope image obtained by observing the cross section of the bonded body of copper alloy and steel material manufactured via LMD in Example 1. FIG. 1B is an SEM image obtained by observing the cross section of the bonded body of copper alloy and steel material manufactured via LMD in Example 1.

FIG. 1C is a chart showing Vickers hardness at various positions in a thickness direction and measured for the cross section of the bonded body of copper alloy and steel material manufactured via LMD in Example 1.

FIG. 2A is an optical microscope image obtained by observing the cross section of a sample, wherein the bonded body of copper alloy and steel material manufactured via LMD in Example 2 is subjected to precipitation hardening process maintained at 315° C. for 3 hours.

FIG. 2B is an SEM image obtained by observing the cross section of the sample, wherein the bonded body of copper alloy and steel material manufactured via LMD in Example 2 is subjected to precipitation hardening process maintained at 315° C. for 3 hours.

FIG. 2C is a chart showing Vickers hardness at various positions in a thickness direction and measured for the cross section of the sample, wherein the bonded body of copper alloy and steel material manufactured via LMD in Example 2 is subjected to precipitation hardening process maintained at 315° C. for 3 hours.

FIG. 3A is an optical microscope image obtained by observing the cross section of the bonded body of a copper alloy/a middle layer/a steel material manufactured via LMD in Example 3.

FIG. 3B is an SEM image obtained by observing the cross section of the bonded body of a copper alloy/a middle layer/a steel material manufactured via LMD in Example 3.

FIG. 3C is a chart showing Vickers hardness at various positions in a thickness direction and measured for the cross section of the bonded body of a copper alloy/a middle layer/a steel material manufactured via LMD in Example 3.

FIG. 4A is an optical microscope image obtained by observing the cross section of a sample, wherein the bonded body of a copper alloy/a middle layer/a steel material manufactured via LMD in Example 4 is subjected to precipitation hardening process maintained at 315° C. for 3 hours.

FIG. 4B is an SEM image obtained by observing the cross section of the sample, wherein the bonded body of a copper alloy/a middle layer/a steel material manufactured via LMD in Example 4 is subjected to precipitation hardening process maintained at 315° C. for 3 hours.

FIG. 4C is a chart showing Vickers hardness at various positions in a thickness direction and measured for the cross section of the sample, wherein the bonded body of a copper alloy/a middle layer/a steel material manufactured via LMD in Example 4 is subjected to precipitation hardening process maintained at 315° C. for 3 hours.

FIG. 5A is an optical microscope image obtained by observing the cross section of the bonded body of copper alloy and steel material manufactured via TIG welding in Example 5 (comparison).

FIG. 5B is an SEM image obtained by observing the cross section of the bonded body of copper alloy and steel material manufactured via TIG welding in Example 5 (comparison).

FIG. 5C is a chart showing Vickers hardness at various positions in a thickness direction and measured for the cross section of the bonded body of copper alloy and steel material manufactured via TIG welding in Example 5 (comparison).

FIG. 6A is an optical microscope image obtained by observing the cross section of the bonded body of copper alloy and steel material manufactured via laser welding in Example 6 (comparison).

FIG. 6B is an SEM image obtained by observing the cross section of the bonded body of copper alloy and steel material manufactured via laser welding in Example 6 (comparison).

FIG. 6C is a chart showing Vickers hardness at various positions in a thickness direction and measured for the cross section of the bonded body of copper alloy and steel material manufactured via laser welding in Example 6 (comparison).

FIG. 7A is an optical microscope image obtained by observing the cross section of the bonded body of a copper alloy/a middle layer/a steel material having an electrical conductivity of 61 IACS % (converted heat conductivity 245 W/mK) and manufactured via LMD in Example 7.

FIG. 7B is an SEM image obtained by observing the cross section of the bonded body of a copper alloy/a middle layer/a steel material having an electrical conductivity of 61 IACS % (converted heat conductivity 245 W/mK) and manufactured via LMD in Example 7.

FIG. 7C is a chart showing Vickers hardness at various positions in a thickness direction and measured for the cross section of the bonded body of a copper alloy/a middle layer/a steel material having an electrical conductivity of 61 IACS % (converted heat conductivity 245 W/mK) and manufactured via LMD in Example 7.

FIG. 8A is an optical microscope image obtained by observing the cross section of the bonded body of a copper alloy/a middle layer/a steel material having an electrical conductivity of 38 IACS % (converted heat conductivity 158 W/mK) and manufactured via LMD in Example 8.

FIG. 8B is an SEM image obtained by observing the cross section of the bonded body of a copper alloy/a middle layer/a steel material having an electrical conductivity of 38 IACS % (converted heat conductivity 158 W/mK) and manufactured via LMD in Example 8.

FIG. 8C is a chart showing Vickers hardness at various positions in a thickness direction and measured for the cross section of the bonded body of a copper alloy/a middle layer/a steel material having an electrical conductivity of 38 IACS % (converted heat conductivity 158 W/mK) and manufactured via LMD in Example 8.

FIG. 9A is an optical microscope image obtained by observing the cross section of a sample, wherein the bonded body of a copper alloy/a middle layer/a steel material having an electrical conductivity of 38 IACS % (converted heat conductivity 158 W/mK) and manufactured via LMD in Example 9 is subjected to precipitation hardening process maintained at 450° C. for 3 hours.

FIG. 9B is an SEM image obtained by observing the cross section of the sample, wherein the bonded body of a copper alloy/a middle layer/a steel material having an electrical conductivity of 38 IACS % (converted heat conductivity 158 W/mK) and manufactured via LMD in Example 9 is subjected to precipitation hardening process maintained at 450° C. for 3 hours.

FIG. 9C is a chart showing Vickers hardness at various positions in a thickness direction and measured for the cross section of the sample, wherein the bonded body of a copper alloy/a middle layer/a steel material having an electrical conductivity of 38 IACS % (converted heat conductivity 158 W/mK) and manufactured via LMD in Example 9 is subjected to precipitation hardening process maintained at 450° C. for 3 hours.

FIG. 10 is optical microscope images obtained by observing the cross section of the LMD bonded body of copper alloy and steel material before and after solution annealing in Example 13 (comparison).

### DETAILED DESCRIPTION OF THE INVENTION

### Bonded Body

The bonded body of the present invention includes the first member composed of a precipitation-hardenable copper alloy and the second member including an additively manufactured object made of a steel material bonded to the first member at at least one bonding interface. This bonded body, when the cross section perpendicular to the bonding interface is observed by a scanning electron microscope (SEM), is free of voids having a length of 50 μm or more at the bonding interface in a direction parallel to the bonding interface. The bonded body having such a composition has high bonding property at the interface of the copper alloy and the steel material, and capable of maintaining a high strength even without carrying out the subsequent precipitation hardening process accompanied by solution annealing (or by carrying out only the precipitation hardening process that is not accompanied by the solution annealing). Particularly, the formation of an additively manufactured object can reduce an amount of heat input, thereby preventing the precipitation-hardenable copper alloy underneath the additively manufactured object from over-age softening (or the over-age softening, even if occurs, has an insignificant impact), and consequently a high strength can be maintained as described above.

As mentioned above, for bonding a steel material and a copper alloy, methods of thermal spraying and welding have been used, however, a copper alloy has a low softening point, and a copper alloy and a steel material have different degrees of the thermal contraction, whereby voids and solidification cracking likely occur at the bonding interface, thereby causing insufficient bonding. Additionally, it is desirable to use a precipitation-hardenable copper alloy, which is a copper alloy having a comparatively high strength, as a mold, however, such a copper alloy, when used, has a softening point as low as from 300 to 500° C., thereby causing the copper alloy to soften due to heat input during bonding to a steel material. This softening can be recovered by solution annealing and the subsequent precipitation hardening process, but the solution annealing requires heat treatment in a high temperature range from 700 to 1000° C. For this reason, voids and the like at the bonding interface spread, thereby inducing early detachment of the steel material. This also applies to the diffusion bonding method as employed in Patent Literature 1. As just described, the bonding of the precipitation-hardenable copper alloy and a steel material has posed issues in 2 viewpoints of bonding reduction and strength reduction. These issues are conveniently solved according to the present invention. Thus, the bonded body of the present invention includes, for example, a steel material on the top surface and a copper alloy on the bottom surface so that both of a strength of the steel material and the heat conductivity property of the copper alloy can be utilized. For example, when this bonded body is used as a mold such as a casting mold and a mold for injection molding or a mold component, precision molding free of deformation is enabled, and a long life can be maintained (durability as a mold is maintained). Further, an iron can be welded to this bonded body, whereby a mold or a mold component can have good repairability and a long life.

The bonded body, when the cross section perpendicular to the bonding interface is observed by a scanning electron microscope (SEM) (e.g., at 100× magnification), is free of voids having a length of 50 μm or more at the bonding interface in a direction parallel to the bonding interface. Such a composition is the same as substantially free of voids at the bonding interface, thereby ensuring high bonding property between a copper alloy and a steel material, in other words, a high bonding quality.

Examples of the precipitation-hardenable copper alloy composing the first member include chromium copper alloys, chromium zirconium copper alloys, titanium copper alloys, nickel silicon copper alloys, nickel tin copper alloys, and beryllium copper alloys, and any combinations of these, with a beryllium copper alloy being more preferable. Examples of the beryllium copper alloys include beryllium copper 25 alloy (JIS alloy number C1720, UNS number C17200), 11 alloy (JIS number C1751, UNS number C17510) and 10 alloy (UNS number C17500). Preferable examples of the chromium copper alloys include UNS alloy number C18200. Preferable examples of the chromium zirconium copper alloys include UNS alloy number C18510 and EN material number CW106C. Preferable examples of the titanium copper alloys include JIS number C1990. Preferable examples of the nickel silicon copper alloys include UNS numbers C70250 and C70350. Preferable examples of the nickel tin copper alloys include UNS alloy numbers C72700, C72950, C72900, and C96900. These precipitation-hardenable copper alloys are well balanced in heat conductivity and strength, and beneficial as the materials for, for example, molds and mold components. When such a copper alloy is used as a mold or a mold component, a high heat conductivity distinctive to a copper alloy can shorten the molding cycle. Of these precipitation-hardenable copper alloys, beryllium copper 25 alloy is the most preferable for the mold applications from viewpoints of the balance in heat conductivity and strength. When considering the balance of heat conductivity and hardness of the precipitation-hardenable copper alloy, the precipitation-hardenable copper alloy preferably has a heat conductivity from 90 to 350 W/m·° C. and a Vickers hardness from HV 130 to 430, more preferably has a heat conductivity from 90 to 280 W/m·° C. and a Vickers hardness from HV 250 to 430, and further preferably has a heat conductivity from 90 to 135 W/m·° C. and a Vickers hardness from HV 320 to 430.

When the precipitation-hardenable copper alloy having a heat conductivity (e.g., 160 W/mK or more) (e.g., beryllium copper 11 alloy (JIS number C1751)) is used herein as the first member, the additive of the second member (a steel material) and a middle layer by laser metal deposition (LMD) may become difficult due to such a high heat conductivity. For avoiding this inconvenience, it is preferable that the precipitation-hardenable copper alloy composing the first member is subjected to solution annealing prior to LMD to adjust a heat conductivity to be low (e.g., less than 160 W/mK), and the precipitation-hardenable copper alloy after forming the second member and the middle layer by LMD is subjected to aging treatment (precipitation hardening process) to adjust the heat conductivity to be high (e.g., 160 W/mK or more). Thus, the precipitation-hardenable copper alloy of the first member preferably has a heat conductivity of 160 W/mK or more after the precipitation hardening process. The precipitation-hardenable copper alloy during this process is preferably at least one alloy selected from the group consisting of chromium copper alloys, chromium zirconium copper alloys, nickel silicon copper alloys and beryllium copper alloys.

The first member (precipitation-hardenable copper alloy) has a Vickers hardness of preferably HV 200 or more, more preferably HV 250 or more, and further preferably HV 300 or more, at the main part wherein a part within 1.0 mm from the bonding interface in a thickness direction is excluded. For example, beryllium copper 25 alloy (JIS alloy number C1720) can have a Vickers hardness of HV 300 or more at the main part. The Vickers hardness at the main part of the first member is not particularly limited in the upper limit, but typically HV 500 or less.

The first member (precipitation-hardenable copper alloy), when over-age softening is not caused by excess heat input during the formation of the second member, can recover the hardness throughout the entire first member by carrying out only the precipitation hardening process that is not accompanied by the solution annealing. In other words, the hardness of the first member, including not only the above main part of the first member but also the part within 1.0 mm from the bonding interface in a thickness direction, can be recovered. The formation of the second member, that does not cause the over-age softening of the first member by excess heat input, is preferably carried out by laser metal deposition (LMD). This is because LMD, compared with other bonding methods, gives a heat amount required for the additive only to a specific narrow area for a short time, thereby, when selecting suitable conditions, preventing the first member from over-age softening and making a layer underneath the additively manufactured object (the second member) a hardenable solution layer. From this viewpoint, the first member composed of the precipitation-hardenable copper alloy has a Vickers hardness of HV 200 or more, and more preferably HV 300 or more, throughout the entirety including a part within 1.0 mm from the bonding interface in a thickness direction and the main part other than the part within 1.0 mm from the bonding interface. Further, the Vickers hardness of the first member at this time is not particularly limited in the upper limit, but is typically HV 500 or less.

Additionally, when the bonded body is subjected to the solution annealing that is not accompanied by the precipitation hardening process at the time of completing the bonding by LMD, the preferable heat treatment temperature varies depending on the alloy type of the first member. For example, the heat treatment temperature for beryllium copper 25 alloy (JIS alloy number C1720) is preferably from 280 to 340° C., for beryllium copper 11 alloy (JIS number C1751), beryllium copper 10 alloy (UNS number C17500), nickel silicon copper alloys (UNS number C70250, C70350), and nickel tin copper alloys (UNS alloy number C72700, C72950, C72900, and C96900) is preferably from 430 to 500° C., for titanium copper alloy (JIS number C1990) is preferably from 480 to 530° C., and for chromium copper alloy (UNS alloy number C18200) and chromium zirconium copper alloys (UNS alloy number C18510, EN material number CW106C) is preferably from 380 to 430° C. The retention time at the above temperatures is preferably from 30 minutes to 5 hours.

When the bonded body is subjected to the solution annealing such that the bonded body is heated at from 700 to 1000° C. for from 30 minutes to 5 hours, followed by water-cooling, the strength of the first member can be completely recovered by the subsequent precipitation hardening process. However, the solution annealing is not preferably applied because it poses problems on the bonded body such as (i) voids and the like spread at the bonding interface due to a high-temperature retention and the thermal shock when water-cooled, thereby inducing early detachment of the additively manufactured object obtained by LMD, and (ii) the additively manufactured object formed by LMD suffers from notable hardness deterioration.

The second member comprises an additively manufactured object made of a steel material. The “additively manufactured object” refers to an object manufactured by the method of additive manufacturing, which is also called 3D printing. Accordingly, the additively manufactured object made of a steel material is, for example, a manufactured object obtained by stacking a powder of a steel material, layers of such a powder and the like, and suitably through melting and solidification. The additively manufactured object made of a steel material (the second member) is preferably formed by laser metal deposition (LMD). LMD can effectively reduce the voids at the bonding interface and effectively avoid the softening of the precipitation-hardenable copper alloy (the first member). Thus, it is possible to effectively achieve a bonded body of copper alloy and steel material that has high bonding property at the interface of the copper alloy and the steel material, and is capable of maintaining a high strength without carrying out the subsequent precipitation hardening process accompanied by solution annealing (or by carrying out only the precipitation hardening process that is not accompanied by the solution annealing).

Examples of the steel material composing the second member include die steel (SKD), high speed tool steel (SKH), stainless steel (SUS), maraging steel, and any combinations of these, with die steel (SKD) being more preferable. Preferable examples of die steel (SKD) include SKD61 (JIS G4404). Preferable examples of high speed tool steel include SKH50 and SKH51 (both in JIS G4403). Preferable examples of stainless steel (SUS) include SUS420 and SUS631 (both in JIS G4305).

The second member may further be provided with a middle layer composed of a heterogeneous metal material on the surface contacting to the first member. In other words, the second member can be a combination of a steel material and a heterogeneous metal material as the middle layer. The middle layer, when provided, has benefits of further improving the bonding between the first member and the second member, and reducing voids remaining at the bonding interface. Additionally, when the heterogeneous metal material composing the middle layer uses, as the main component, an element having a high solid solubility in the materials used respectively for the second member and the first member, there are benefits of further improving the bonding between the first member and the second member, and further reducing or completely preventing voids from remaining at the bonding interface. From these viewpoints, the heterogeneous metal material composing the middle layer is preferably an alloy comprising Ni as the main component, and examples of such a heterogeneous metal include nickel alloys, with a nickel-chromium-iron alloy comprising Ni as the main component being more preferable. The “Ni as the main component” herein means the Ni content in a heterogeneous metal is typically 50% by weight or more, and more typically from 50 to 85% by weight. When the middle layer comprising such Ni as the main component is provided, the bonded body having smaller voids at the bonding interface can be effectively obtained. In other words, when the cross section perpendicular to the bonding interface of the bonded body is observed by a scanning electron microscope (SEM), it is possible to effectively achieve the bonded body free of voids having a length of 10 μm or more at the bonding interface in a direction parallel to the bonding interface. This middle layer can be preferably formed using LMD on the copper alloy. Further, when the bonded body includes the middle layer, the SEM observation of voids described above means to observe the interface of the copper alloy and the middle layer.

The steel material of the second member preferably has a Vickers hardness of HV 300 or more, more preferably HV 400 or more, and further preferably HV 500 or more, at the main part wherein a part within 1.0 mm from the bonding interface in a thickness direction is excluded. The Vickers hardness at the main part of the steel material is not particularly limited in the upper limit, but typically HV 1000 or less.

### Application

The bonded body of the present invention can be used in various applications, but is preferable to use in applications, such that both of the benefits of the precipitation-hardenable copper alloy (high heat conductivity property and high strength) and the benefits of the steel material (e.g., extremely high strength) are utilized. Examples of such an application include a mold and a mold component. As described above, materials for automotive functional parts often include engineering plastics and glass fibers for weight reduction and strength enhancement. When these materials are molded using a mold made of a copper alloy, the copper alloy wears due to a hard glass fiber. When a mold on which a steel material is coated is used, the steel material detaches due to molding. To the contrary, when a mold using the bonded body of the present invention is used, the issues of wearing of a copper alloy and detachment of a steel material can be solved while quickly cooling the materials. Thus, a preferable embodiment of the present invention accordingly provides an article comprising the above bonded body and selected from a mold and a mold component. The bonded body according to this embodiment is capable of achieving precision molding free of deformation as a mold such as a casting mold and a mold for injection molding, and of maintaining a long life (durability as a mold is maintained).

Examples of other applications include a heat exchanger, a bearing, and a component for a semiconductor manufacturing apparatus.

### Manufacturing Method

As described above, the bonded body of the present invention can be preferably manufactured using laser metal deposition (LMD). According to LMD, it is possible to effectively achieve a bonded body that prevents the bonding reduction at the bonding interface and the strength reduction of a copper alloy. Generally, as for the welding of a copper alloy, a copper alloy itself has a high heat conductivity, thereby diffusing the heat and making it difficult to weld with high precision. For this reason, the conventional bonding methods such as TIG welding, laser welding, and welding by the diffusion bonding method, require a high heat input. However, a copper alloy whose softening point is comparative low softens when a high heat input exceeds the softening temperature. For recovering this softening, solution annealing and the subsequent precipitation hardening process can be carried out, but the solution annealing causes voids to spread at the bonding interface of a copper alloy and a steel material. When the bonding is carried out by laser welding, a heat input can be comparatively concentrated, but copper itself intensely reflects the laser beam (although the light reflection can be somewhat diminished when a green laser is used), thereby generally making it difficult to obtain a desired bonded body. Additionally, conventional bonding methods pose issues such as entrapping the air during the welding and generating hydrogen, thereby causing porosity (also called blow hole, which is a hollow weld defect formed by a gas entrapped while solidifying a weld metal) and solidification cracking and the like from different melting points between a copper alloy and a steel material. In this respect, LMD, when employed, can conveniently solve these issues. In other words, LMD accordingly i) does not require a high heat input, and thus can prevent voids and solidification cracking at the bonding interface from occurring due to different degrees of the thermal contraction between a copper alloy and a steel material while preventing the copper alloy from softening, and ii) can improve the property of the copper alloy without requiring the precipitation hardening process after welding (or, even when the precipitation hardening process is carried out, only the precipitation hardening process that is not accompanied by the solution annealing is carried out), thereby preventing voids at the bonding interface from spreading.

LMD is a welding method different from the laser welding. LMD is described as follows. First, a laser beam locally heats a base material (a copper alloy in the present invention) thereby to form a molten pool. Then, a fine metal powder (a steel material powder in the present invention) is directly injected to the molten pool from the nozzle of an optical processing head. The powder melts there and bonds to the base material. Multiple layers can be optionally overlaid and constructed, and the optical processing head moves around on the base material by automatic control, thereby forming a line, a plane and a specific shape. On the other hand, the laser welding is a method that mainly irradiates metals with a laser beam as a heat source in a beam-condensing state, thereby allowing the metals to locally melt and solidify for bonding.

According to a preferable embodiment of the present invention, the bonded body of the present invention can be manufactured by (a) providing the first member composed of the precipitation-hardenable copper alloy which has been subjected to solution annealing, or solution annealing and aging treatment, and (b) forming, as the second member, an additively manufactured object composed of a steel material by LMD using a powder of the steel material on or above the surface of the first member. Specific description is as follows.

### (a) Provision of the Precipitation-Hardenable Copper Alloy

First, the first member composed of the precipitation-hardenable copper alloy is provided. For this precipitation-hardenable copper alloy, those described previously can be used. Thus, the preferable precipitation-hardenable copper alloy is at least one alloy selected from the group consisting of chromium copper alloys, chromium zirconium copper alloys, titanium copper alloys, nickel silicon copper alloys, nickel tin copper alloys, and beryllium copper alloys, with beryllium copper alloys being particularly preferable.

The precipitation-hardenable copper alloy to be used as the first member is preferably subjected to solution annealing, or solution annealing and aging treatment. By doing this, the precipitation-hardenable copper alloy is tempered, and a desired high strength can be presented. The solution annealing and aging treatment are carried out in accordance with known conditions according to the precipitation-hardenable copper alloy to be used, and is not limited. The precipitation-hardenable copper alloy is subjected at least to the solution annealing, and the aging treatment is optional as long as the desired property is obtained. This is because even when the aging treatment is not carried out, the heat input by LMD may be substituted for the aging treatment.

As described above, when the precipitation-hardenable copper alloy (e.g., beryllium copper 11 alloy (JIS number C1751)) having a high heat conductivity (e.g., 160 W/mK or more (this value can be converted from the electrical conductivity actually measured using an eddy current conductivity meter, and such an electrical conductivity is 38.32 IACS % or more)) is used as the first member, the additive of the second member (a steel material) and a middle layer by laser metal deposition (LMD) may become difficult due to such a high heat conductivity. For avoiding this inconvenience, it is preferable that the precipitation-hardenable copper alloy composing the first member is subjected to solution annealing prior to LMD to adjust a heat conductivity to be low (e.g., less than 160 W/mK), and the precipitation-hardenable copper alloy after forming the second member and the middle layer by LMD is subjected to aging treatment (precipitation hardening process) to adjust the heat conductivity to be high (e.g., 160 W/mK or more). In other words, when the precipitation-hardenable copper alloy has a heat conductivity of 160 W/mK or more after the precipitation hardening process, it is preferable that (i) the precipitation-hardenable copper alloy composing the first member, before forming the second member, is subjected to solution annealing so that a heat conductivity is less than 160 W/mK, and (ii) the precipitation-hardenable copper alloy composing the first member, after forming the second member, is subjected to precipitation hardening process so that a heat conductivity of the precipitation-hardenable copper alloy is adjusted to be 160 W/mK or more. The precipitation-hardenable copper alloy during this process is preferably at least one alloy selected from the group consisting of chromium copper alloys, chromium zirconium copper alloys, nickel silicon copper alloys and beryllium copper alloys.

### (b) Addition Manufacturing of a Steel Material by LMD

An additively manufactured object composed of a steel material is formed as the second member by LMD using a powder of the steel material on the surface of the first member. The bonded body of the present invention is thus obtained. For the steel material, those described previously can be used. Thus, the preferable steel material is composed of at least one steel selected by the group consisting of die steel (SKD), high speed tool steel (SKH), stainless steel (SUS), and maraging steel. The powder of a steel material is not particularly limited in the particle size as long as it is additively manufacturable by LMD, but, for example, the D50 particle size on a volume basis can be 10 to 100 μm.

In LMD, an additively manufactured object composed of a steel material (the second member) is formed on a copper alloy, while the copper alloy (the first member) is allowed to move relatively to the nozzle which injects the powder of a steel material. The feed rate of the first member (copper alloy) to the nozzle is preferably 100 to 2000 mm/min, more preferably 300 to 1200 mm/min, and further preferably 600 to 1000 mm/min. The spot diameter of the nozzle which injects the powder of a steel material is preferably 0.4 to 8.5 mm, more preferably 0.4 to 4.5 mm, and further preferably 0.6 to 3.5 mm. The average feed mass of the powder is preferably 40 g/min or less, more preferably 1.0 to 18.0 g/min, and further preferably 1.6 to 9.0 g/min. The average feed mass is calculated based on the total time including intermittence and cooling down time.

The formation of the additively manufactured object by LMD is carried out in an average amount of heat input of preferably 2000 W/sec·mm² or less, more preferably from 200 to 1300 W/sec·mm², and preferably from 250 to 1100 W/sec·mm^{2.} The average amount of heat input is calculated based on the total time including intermittence and cooling down time. The average amount of heat input can be calculated by dividing a laser output (W) per second by an area (mm²) of the spot diameter. For example, when a spot diameter is 3.5 mm and a laser output per second is 2600 W in LMD to calculate 2600/((3.5/2)²×3.14) using these values, the average amount of heat input is calculated to be about 270 W/sec·mm². The laser output used for LMD is preferably from 100 to 4000 W, more preferably from 200 to 3000 W, and further preferably from 300 to 2600 W. The interlayer cooling time in LMD (in other words, the cooling time after forming a layer by LMD until the next layer is added thereonto) is preferably 3 seconds or more, more preferably 100 seconds or more, and further preferably 200 seconds or more.

After forming the additively manufactured object (the second member) by LMD, the bonded body is optionally retained at a temperature from 280 to 340° C. for from 30 minutes to 5 hours, thereby to carry out the precipitation hardening process. As described previously, the copper alloy has softened due to heat input during bonding to a steel material. This softening can be recovered by solution annealing and the subsequent precipitation hardening process, but particularly the solution annealing requires heat treatment in a high temperature range from 700 to 1000° C. For this reason, voids and the like at the bonding interface spread, thereby inducing early detachment of the steel material. In this respect, it is possible to effectively manufacture a bonded body of copper alloy and steel material that has high bonding property at the interface of the copper alloy and the steel material, and is capable of maintaining a high strength by carrying out the precipitation hardening process that is not accompanied by solution annealing under the above heat treatment conditions. In the obtained bonded body particularly, the first member composed of the precipitation-hardenable copper alloy can have a Vickers hardness of HV 200 or more throughout the entirety including a part within 1.0 mm from the bonding interface in a thickness direction and the main part other than the part within 1.0 mm from the bonding interface.

During and thereafter the LMD, it is desired that the first member is not retained at a temperature of 400° C. or more for 10 minutes or more, and the first member is not retained at a temperature of 500° C. or more for 3 minutes or more. This is because the bonded body according to the present invention can demonstrate a desired high strength even when is not subjected to a high temperature heat treatment such as solution annealing (this causes the softening of a copper alloy, and occurrence and spread of voids). In other words, when the retention at 400° C. or more×10 minutes or more, and at 500° C. or more×3 minutes or more are avoided, the spread of voids at the bonding interface can be effectively prevented. Accordingly, it is desirable that the formation of the additively manufactured object by LMD adjusts the conditions described above (e.g., feed rate, laser output, interlayer cooling time, average feed mass of the powder, and heat capacity of the first member) so that the retention at 400° C. or more×10 minutes or more, and at 500° C. or more×3 minutes or more are avoided.

When the second member includes the middle layer, it is preferable that the middle layer composed of a heterogeneous metal material is formed on the copper alloy by the LMD additive manufacturing, and then the additive manufacturing of the steel material by LMD described in the above (b) is carried out on this middle layer. In other words, the method for manufacturing the bonded body according to the preferable embodiment further includes a step of, prior to forming an additively manufactured object composed of a steel material, forming a middle layer by LMD using a powder of alloy comprising heterogeneous metals other than Cu and Fe as the main component on the surface of the first member, and the formation of the additively manufactured object composed of a steel material by LMD using a powder of the steel material is performed on the surface of the middle later. Further, as described previously, the heterogeneous metal material composing the middle layer is preferably an alloy comprising Ni as the main component, and examples of such a heterogeneous metal include nickel alloys, with a nickel-chromium-iron alloy comprising Ni as the main component being more preferable.

### EXAMPLES

The present invention will be further specifically described in reference to the following examples.

### Example 1

A bonded body of copper alloy and steel material was manufactured by laser metal deposition (LMD) as follows. First, a copper alloy plate (made of beryllium copper 25 alloy (JIS alloy number C1720), dimension 100 mm×50 mm, thickness 10 mm) was provided. This copper alloy plate was subjected to solution annealing and aging treatment in advance. The surface to be used for bonding to the steel material of the copper alloy plate was washed with acetone. Using a laser additive manufacturing machine (model name: MU-6300V LASER EX, a product of OKUMA CORPORATION), a steel powder (made of die steel (JIS G4404 SKD61), nominal particle size: −90/+45 μm) was fed to and melted on the bonding surface of the copper alloy plate by LMD, thereby to form an additively manufactured object. The notation, nominal particle size “−A/+B μm”, is the general notation style on the powder grade meaning that a particle does not pass through a sieve opening of B um but passes through a sieve opening of A μm, and it should be noted that the later descriptions using the same notation style mean the same. This LMD was carried out under the following conditions while the copper alloy plate was allowed to move relatively in a desired direction against the nozzle which injects the steel material powder:
Carrier gas: He
Laser output: 1400 W
Average amount of heat input: 146 W/sec·mm² (calculated based on the total time including intermittence and cooling down time)
Spot diameter: Diameter 3.5 mm
Average feed mass of steel powder: 7.8 g/min (calculated based on the total time including intermittence and cooling down time)
Feed rate of copper alloy plate: 800 mm/min
Interlayer cooling time: 220 sec (the cooling time after forming a layer by LMD until the next layer is added thereonto)

In this way, the LMD bonded body of the first member composed of the copper alloy and the second member composed of the steel material was obtained.

During and thereafter the LMD, the copper alloy (the first member) was not retained at a temperature of 400° C. or more for 10 minutes or more, nor retained at a temperature of 500° C. or more for 3 minutes or more. Accordingly, the bonded body after LMD was not subjected to the solution annealing. The thus obtained bonded body of the copper alloy/the steel material was evaluated as follows.

### Cross Section Observation

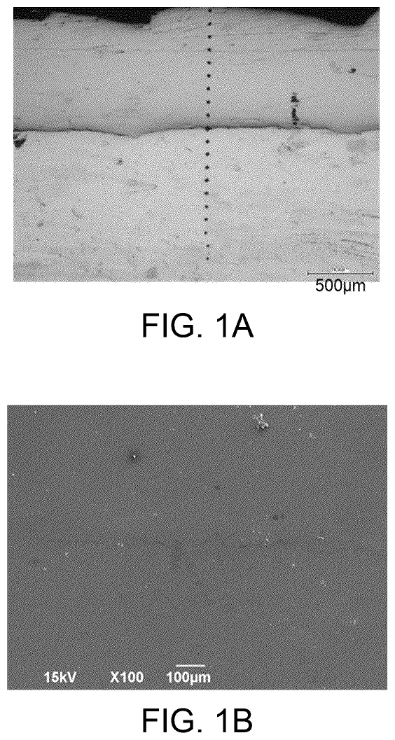

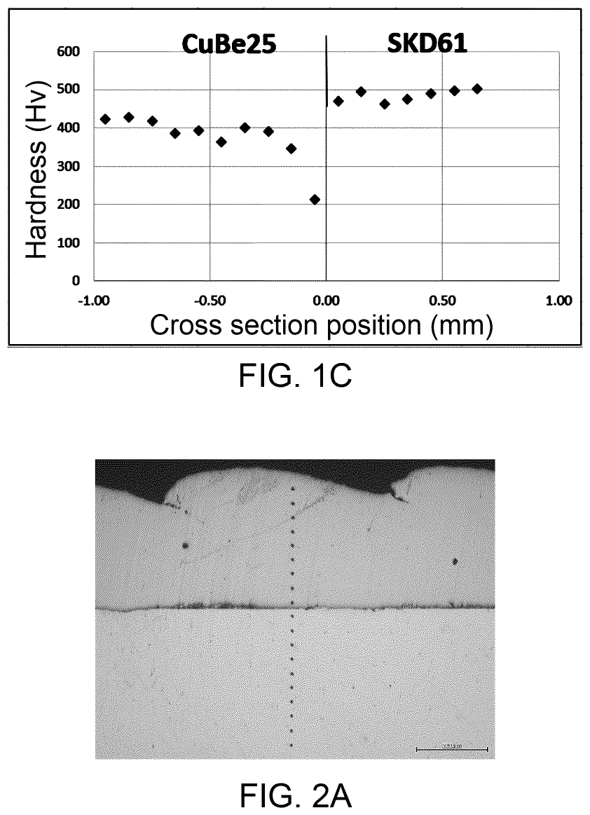

The cross section perpendicular to the bonding interface of the bonded body was cut out using a diamond cutter and polished. The polished cross section including the bonding interface was observed by an optical microscope at 50× magnification, thereby obtaining the image shown in FIG. 1A. Similarly, the polished cross section including the bonding interface was observed by a scanning electron microscope (SEM) at 100× magnification, thereby obtaining the image shown in FIG. 1B. As evident from FIGS. 1A and 1B, it was verified that the bonding interface is free of voids having a length of 50 μm or more in a direction parallel to the bonding interface.

### Vickers Hardness Measurement

Vickers hardness at various positions in a thickness direction (a direction perpendicular to the bonding interface) of the bonded body were measured in conformity with JIS Z 2244: 2009. Table 1 shows Vickers hardness HV of the first member composed of the copper alloy and the second member composed of the steel material respectively. Additionally, FIG. 1C shows a plot of Vickers hardness (HV) at various positions close to the bonding interface. The abscissa axis in FIG. 1C means the distance (mm) from the bonding interface of the bonded body, wherein the plus (+) side corresponds to the second member composed of the steel material, and the minus (−) side corresponds to the first member composed of the copper alloy, respectively.

### Example 2

A bonded body manufactured under the same conditions as in Example 1 was subjected to the precipitation hardening process without carrying out the solution annealing. In the precipitation hardening process, the bonded body was put in a common heat treatment furnace, in which a temperature was raised at a rate of 10° C./min under a nitrogen atmosphere and retained at 315±5° C. for 3 hours, then the bonded body was cooled in the furnace, and taken out after reached room temperature.

### Cross Section Observation

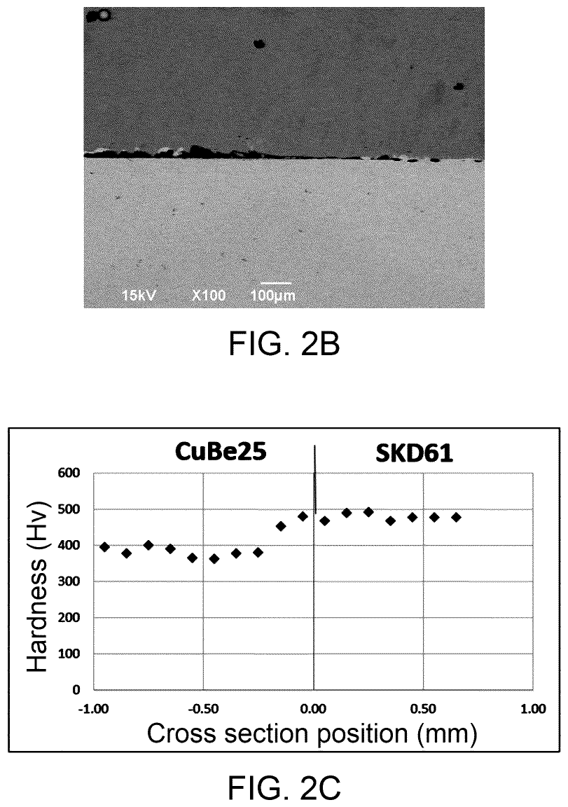

The polished cross section including the bonding interface processed by the same method as in Example 1 was observed by an optical microscope at 50× magnification, thereby obtaining the image shown in FIG. 2A. Similarly, the polished cross section including the bonding interface was observed by a scanning electron microscope (SEM) at 100× magnification, thereby obtaining the image shown in FIG. 2B. As evident from FIGS. 2A and 2B, it was verified that, even when the bonding specimen was subjected to the precipitation hardening process, the bonding interface, as in Example 1, is free of voids having a length of 50 μm or more in a direction parallel to the bonding interface.

### Vickers Hardness Measurement

Vickers hardness at various positions in a thickness direction (a direction perpendicular to the bonding interface) of the bonded body were measured by the same method as in Example 1. Table 1 shows Vickers hardness HV of the first member composed of the copper alloy and the second member composed of the steel material. Additionally, FIG. 2C shows a plot of Vickers hardness (HV) at various positions close to the bonding interface. The way of reading the abscissa axis in FIG. 2C is as described in FIG. 1C.

### Example 3

A bonded body of a copper alloy/a middle layer/a steel material was manufactured as following by laser metal deposition (LMD) as follows. First, a copper alloy plate was provided in the same manner as in Example 1. The surface of the copper alloy plate to be used for bonding to the middle layer was washed with acetone. Using a laser additive manufacturing machine (model name: MU-6300V LASER EX, a product of OKUMA CORPORATION), a powder composing the middle layer (a nickel-chromium-iron alloy having a Ni content of 50% by weight or more, nominal particle size: −90/+15 μm) was fed to and melted on the bonding surface of the copper alloy plate by LMD, thereby to form an additively manufactured object of the middle layer. This LMD was carried out under the following conditions while the copper alloy plate was allowed to move relatively in a desired direction against the nozzle which injects the powder composing the middle layer:
Carrier gas: He
Laser output: 1000 W
Average amount of heat input: 263 W/sec·mm² (calculated based on the total time including intermittence and cooling down time)
Spot diameter: Diameter 2.2 mm
Average feed mass of steel powder: 4.2 g/min (calculated based on the total time including intermittence and cooling down time)
Feed rate of copper alloy plate: 800 mm/min
Interlayer cooling time: 150 sec (the cooling time after forming a layer by LMD until the next layer is added thereonto)

Subsequently, using the above laser additive manufacturing machine, a steel powder (made of die steel (JIS G4404 SKD61), nominal particle size: −90/+45 μm) was fed to and melted at the middle layer by LMD, thereby to form an additively manufactured object. This LMD was carried out under the following conditions while the copper alloy plate on which the middle layer was added was allowed to move relatively in a desired direction against the nozzle which injects the steel powder:
Carrier gas: He
Laser output: 1050 W
Average amount of heat input: 198 W/sec·mm² (calculated based on the total time including intermittence and cooling down time)
Spot diameter: Diameter 2.6 mm
Average feed mass of steel powder: 5.6 g/min (calculated based on the total time including intermittence and cooling down time)
Feed rate of copper alloy plate: 800 mm/min
Interlayer cooling time: 105 sec (the cooling time after forming a layer by LMD until the next layer is added thereonto)

In this way, the LMD bonded body of the first member composed of the copper alloy, the middle layer, and the second member composed of the steel material was obtained.

During and thereafter the LMD, the copper alloy (the first member) was not retained at a temperature of 400° C. or more for 10 minutes or more, nor retained at a temperature of 500° C. or more for 3 minutes or more. Accordingly, the bonded body after LMD was not subjected to the solution annealing.

### Cross Section Observation

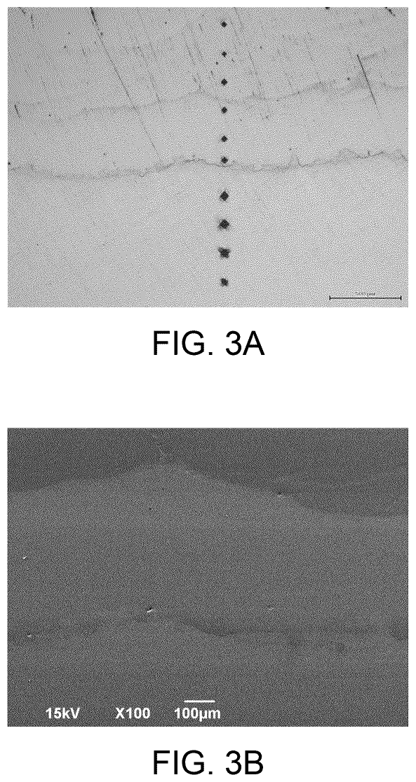

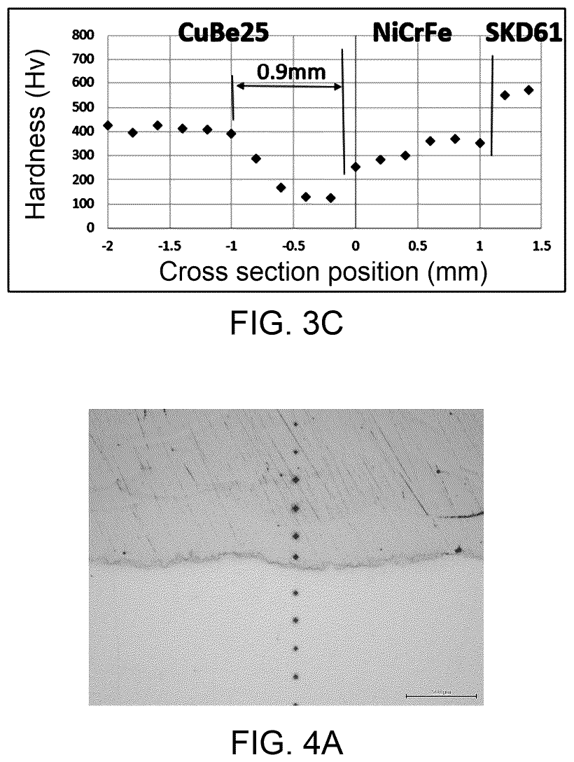

The polished cross section including the bonding interface of the copper alloy and the middle layer and processed by the same method as in Example 1 was observed by an optical microscope at 50× magnification, thereby obtaining the image shown in FIG. 3A. Similarly, the polished cross section including the bonding interface was observed by a scanning electron microscope (SEM) at 100× magnification, thereby obtaining the image shown in FIG. 3B. As a result, as evident from FIGS. 3A and 3B, it was verified that the bonding interface, as in Example 1, is free of voids having a length of 50 μm or more in a direction parallel to the bonding interface.

### Vickers Hardness Measurement

Vickers hardness at various positions in a thickness direction (a direction perpendicular to the bonding interface) of the bonded body were measured by the same method as in Example 1. Table 1 shows Vickers hardness HV of the first member composed of the copper alloy and the steel material of the second member. Additionally, FIG. 3C shows a plot of Vickers hardness (HV) at various positions close to the bonding interface. The abscissa axis in FIG. 3C means the distance (mm) from the bonding interface of the bonded body, wherein the plus (+) side corresponds to the second member composed of the steel material and the middle layer, and the minus (−) side corresponds to the first member composed of the copper alloy, respectively.

### Example 4

The bonded body manufactured under the same conditions as in Example 3 was subjected to the precipitation hardening process without carrying out the solution annealing. In the precipitation hardening process, the bonded body was put in a common heat treatment furnace, in which a temperature was raised at a rate of 10° C./min under a nitrogen atmosphere and retained at 315±5° C. for 3 hours, then the bonded body was cooled in the furnace, and taken out after reached room temperature.

### Cross Section Observation

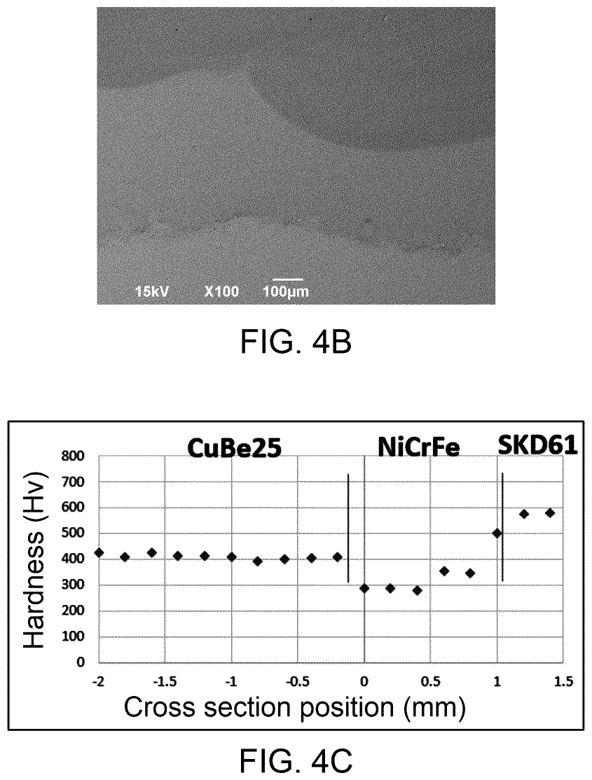

The polished cross section including the bonding interface of the copper alloy and the middle layer, and processed by the same method as in Example 1 was observed by an optical microscope at 50× magnification, thereby obtaining the image shown in FIG. 4A. Similarly, the polished cross section including the bonding interface was observed by a scanning electron microscope (SEM) at 100× magnification, thereby obtaining the image shown in FIG. 4B. As evident from FIGS. 4A and 4B, it was verified that the bonding interface, as in Example 1, is free of voids having a length of 50 μm or more in a direction parallel to the bonding interface.

### Vickers Hardness Measurement

Vickers hardness at various positions in a thickness direction (a direction perpendicular to the bonding interface) of the bonded body were measured by the same method as in Example 1. Table 1 shows Vickers hardness HV of the first member composed of the copper alloy and the steel material of the second member. Additionally, FIG. 4C shows a plot of Vickers hardness (HV) at various positions close to the bonding interface. The abscissa axis in FIG. 4C means the distance (mm) from the bonding interface of the bonded body, wherein the plus (+) side corresponds to the second member composed of the steel material and the middle layer, and the minus (−) side corresponds to the first member composed of the copper alloy, respectively.

Example 5 (Comparison)

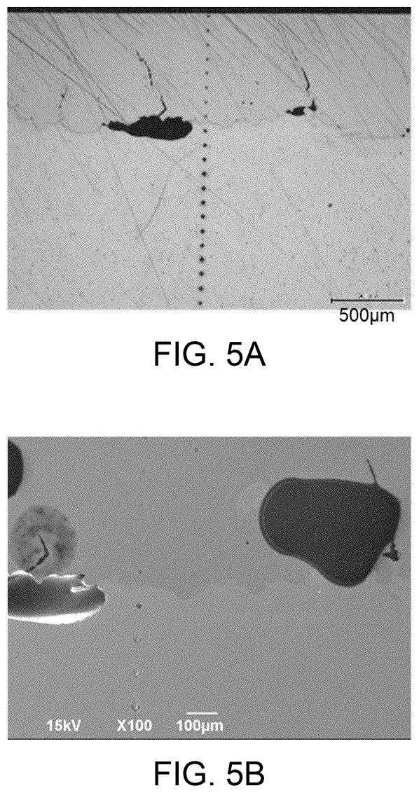

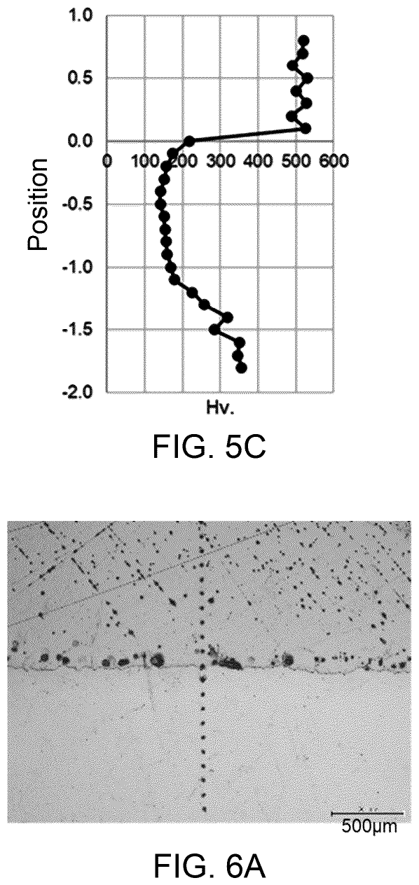

A bonded body of copper alloy and steel material was manufactured by TIG welding as follows. First, a copper alloy plate (made of beryllium copper 25 alloy (JIS alloy number C1720), dimension 100 mm×50 mm, thickness 10 mm) was provided. This copper alloy plate was subjected to solution annealing and aging treatment in advance. The surface of the copper alloy plate to be used for bonding to the steel material was washed with acetone. On the other hand, a welding rod (diameter from 0.1 to 1.0 mm) made of die steel (JIS G4404 SKD61) was provided and the surface thereof was washed with acetone. A steel material layer was formed on the surface of the copper alloy plate by TIG welding using the welding rod (steel material). In this TIG welding, arc discharge was caused between a tungsten electrode (diameter 3.2 mm) and the copper alloy plate with a welding current of 250 A while applying an Ar gas to the weld area, thereby allowing the welding rod to melt. In this way, the TIG welded bonded body of the first member composed of the copper alloy and the second member composed of the steel material was obtained. The obtained bonded body was evaluated as in Example 1. The results were as shown in FIGS. 5A to 5C and Table 1. The ordinate axis in FIG. 5C means the distance (mm) from the bonding interface of the bonded body, wherein the plus (+) side corresponds to the second member composed of the steel material, and the minus (−) side corresponds to the first member composed of the copper alloy, respectively.

### Example 6 (Comparison)

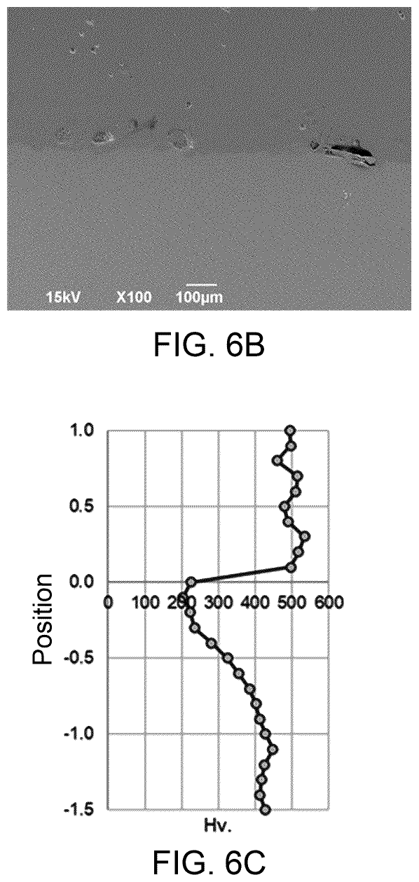

A bonded body of copper alloy and steel material was manufactured by laser welding as follows. First, a copper alloy plate (made of beryllium copper 25 alloy (JIS alloy number C1720), dimension 100 mm×50 mm, thickness 10 mm) was provided. This copper alloy plate was subjected to solution annealing and aging treatment in advance. The surface of the copper alloy plate to be used for bonding to the steel material was washed with acetone. On the other hand, a welding rod (diameter from 0.1 to 1.0 mm) made of die steel (JIS G4404 SKD61) was provided and the surface thereof was washed with acetone. A steel material layer was formed on the surface of the copper alloy plate by laser welding using the welding rod (steel material). In this laser welding, the weld area was irradiated with YAG laser (laser output: 5 KW) while applying an Ar gas, thereby allowing the welding rod to melt. During this operation, the welding speed was 1.5 m/min. In this way, the laser welded bonded body of the first member composed of the copper alloy and the second member composed of the steel material was obtained. The obtained bonded body was evaluated as in Example 1. The results were as shown in FIGS. 6A to 6C and Table 1. The way of reading the ordinate axis in FIG. 6C is as described in FIG. 5C.

### Example 7

A bonded body of a copper alloy/a middle layer/a steel material was manufactured by laser metal deposition (LMD) as follows. First, a copper alloy plate (made of beryllium copper 11 alloy (JIS number C1751), hardness HV from 245 to 270, electrical conductivity 61 IACS % (converted heat conductivity 245 W/mK), dimension 100 mm×50 mm, thickness 10 mm) was provided. This copper alloy plate was subjected to solution annealing and aging treatment in advance. The surface of the copper alloy plate to be used for bonding to the middle layer was washed with acetone. Using a laser additive manufacturing machine (model name: MU-6300V LASER EX, a product of OKUMA CORPORATION), a powder composing the middle layer (a nickel-chromium-iron alloy having a Ni content of 50% by weight or more, nominal particle size: −90/+15 μm) was fed to and melted on the bonding surface of the copper alloy plate by LMD, thereby to form an additively manufactured object of the middle layer. This LMD was carried out under the following conditions while the copper alloy plate was allowed to move relatively in a desired direction against the nozzle which injects the powder composing the middle layer:
Carrier gas: He
Laser output: 1600 W
Average amount of heat input: 302 W/sec·mm² (calculated based on the total time including intermittence and cooling down time)
Spot diameter: Diameter 2.6 mm
Average feed mass of steel powder: 4.2 g/min (calculated based on the total time including intermittence and cooling down time)
Feed rate of copper alloy plate: 600 mm/min
Interlayer cooling time: 150 sec (the cooling time after forming a layer by LMD until the next layer is added thereonto)

Subsequently, using the above laser additive manufacturing machine, a steel powder (made of die steel (JIS G4404 SKD61), nominal particle size: −90/+45 μm) was fed to and melted at the middle layer by LMD, thereby to form an additively manufactured object. This LMD was carried out under the following conditions while the copper alloy plate on which the middle layer was added was allowed to move relatively in a desired direction against the nozzle which injects the steel powder:
Carrier gas: He
Laser output: 1050 W
Average amount of heat input: 198 W/sec·mm² (calculated based on the total time including intermittence and cooling down time)
Spot diameter: Diameter 2.6 mm
Average feed mass of steel powder: 5.6 g/min (calculated based on the total time including intermittence and cooling down time)
Feed rate of copper alloy plate: 800 mm/min
Interlayer cooling time: 105 sec (the cooling time after forming a layer by LMD until the next layer is added thereonto)

In this way, the LMD bonded body of the first member composed of the copper alloy, the middle layer, and the second member composed of the steel material was obtained.

During and thereafter the LMD, the copper alloy (the first member) was not retained at a temperature of 400° C. or more for 10 minutes or more, nor retained at a temperature of 500° C. or more for 3 minutes or more. Accordingly, the bonded body after LMD was not subjected to the solution annealing.

### Cross Section Observation

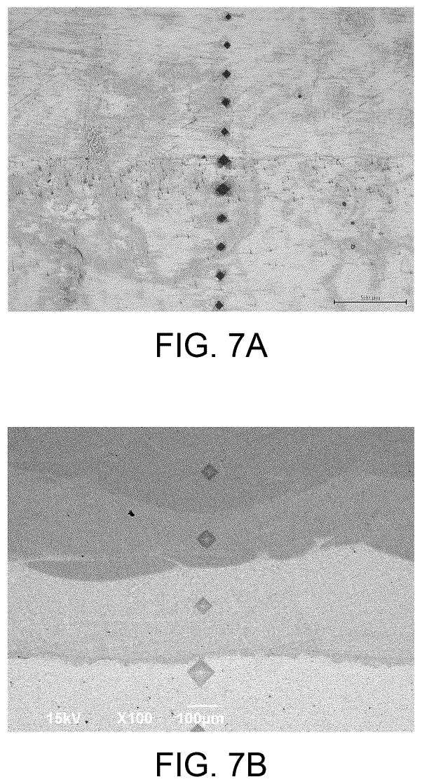

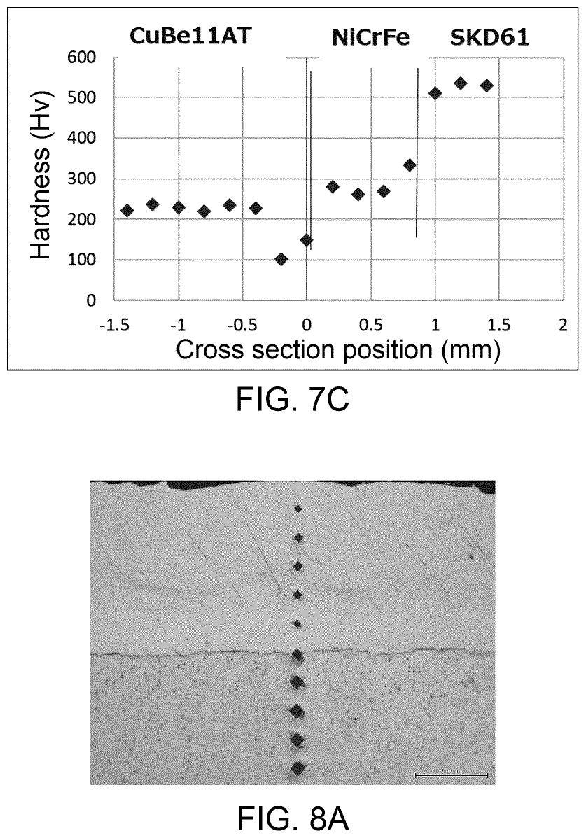

The polished cross section including the bonding interface of the copper alloy and the middle layer and processed by the same method as in Example 1 was observed by an optical microscope at 50× magnification, thereby obtaining the image shown in FIG. 7A. Similarly, the polished cross section including the bonding interface was observed by a scanning electron microscope (SEM) at 100× magnification, thereby obtaining the image shown in FIG. 7B. As evident from FIGS. 7A and 7B, it was verified that the bonding interface, as in Example 1, is free of voids having a length of 50 μm or more in a direction parallel to the bonding interface. However, it was verified that voids having a length of 10 μm or more were partially present in a direction parallel to the bonding interface.

### Vickers Hardness Measurement

Vickers hardness at various positions in a thickness direction (a direction perpendicular to the bonding interface) of the bonded body were measured by the same method as in Example 1. Table 1 shows Vickers hardness HV of the first member composed of the copper alloy and the steel material of the second member. Additionally, FIG. 7C shows a plot of Vickers hardness (HV) at various positions close to the bonding interface. The abscissa axis in FIG. 7C means the distance (mm) from the bonding interface of the bonded body, wherein the plus (+) side corresponds to the second member composed of the steel material and the middle layer, and the minus (−) side corresponds to the first member composed of the copper alloy, respectively.

### Example 8

A bonded body of a copper alloy/a middle layer/a steel material was manufactured by laser metal deposition (LMD) as follows. First, a copper alloy plate (made of beryllium copper 11 alloy (JIS number C1751), hardness HV from 105 to 120, electrical conductivity 38 IACS % (converted heat conductivity 158 W/mK), dimension 100 mm x 50 mm, thickness 10 mm) was provided. This copper alloy plate was subjected to solution annealing only in advance. The surface of the copper alloy plate to be used for bonding to the middle layer was washed with acetone. Using a laser additive manufacturing machine (model name: MU-6300V LASER EX, a product of OKUMA CORPORATION), a powder composing the middle layer (a nickel-chromium-iron alloy having a Ni content of 50% by weight or more, nominal particle size: −90/+15 μm) was fed to and melted on the bonding surface of the copper alloy plate by LMD, thereby to form an additively manufactured object of the middle layer. This LMD was carried out under the following conditions while the copper alloy plate was allowed to move relatively in a desired direction against the nozzle which injects the powder composing the middle layer:
Carrier gas: He
Laser output: 1600 W
Average amount of heat input: 302 W/sec·mm² (calculated based on the total time including intermittence and cooling down time)
Spot diameter: Diameter 2.6 mm
Average feed mass of steel powder: 4.2 g/min (calculated based on the total time including intermittence and cooling down time)
Feed rate of copper alloy plate: 800 mm/min
Interlayer cooling time: 150 sec (the cooling time after forming a layer by LMD until the next layer is added thereonto)

Subsequently, using the above laser additive manufacturing machine, a steel powder (made of die steel (JIS G4404 SKD61), nominal particle size: −90/+45 μm) was fed to and melted at the middle layer by LMD, thereby to form an additively manufactured object. This LMD was carried out under the following conditions while the copper alloy plate on which the middle layer was added was allowed to move relatively in a desired direction against the nozzle which injects the steel powder:
Carrier gas: He
Laser output: 1050 W
Average amount of heat input: 198 W/sec·mm² (calculated based on the total time including intermittence and cooling down time)
Spot diameter: Diameter 2.6 mm
Average feed mass of steel powder: 5.6 g/min (calculated based on the total time including intermittence and cooling down time)
Feed rate of copper alloy plate: 800 mm/min
Interlayer cooling time: 105 sec (the cooling time after forming a layer by LMD until the next layer is added thereonto)

In this way, the LMD bonded body of the first member composed of the copper alloy, the middle layer, and the second member composed of the steel material was obtained.

During and thereafter the LMD, the copper alloy (the first member) was not retained at a temperature of 400° C. or more for 10 minutes or more, nor retained at a temperature of 500° C. or more for 3 minutes or more. Accordingly, the bonded body after LMD was not subjected to the solution annealing.

### Cross Section Observation

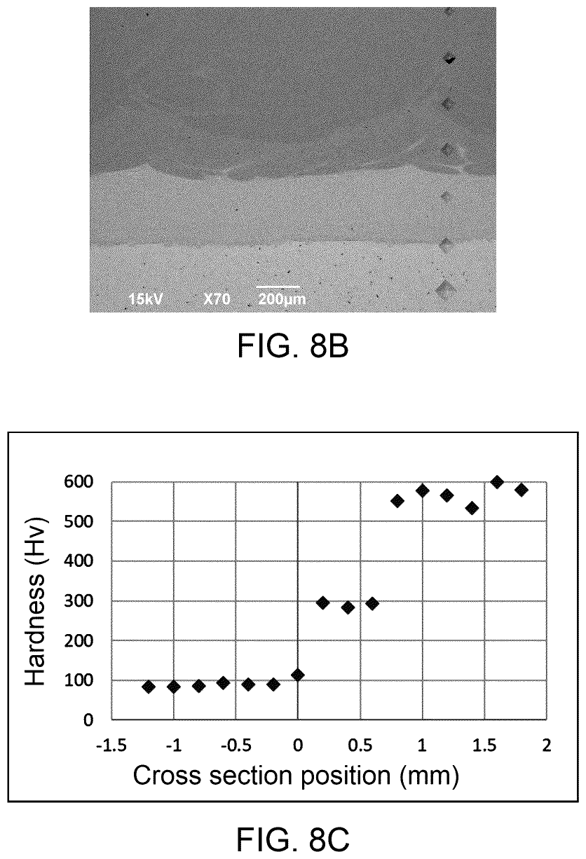

The polished cross section including the bonding interface of the copper alloy and the middle layer and processed by the same method as in Example 1 was observed by an optical microscope at 50× magnification, thereby obtaining the image shown in FIG. 8A. Similarly, the polished cross section including the bonding interface was observed by a scanning electron microscope (SEM) at 100× magnification, thereby obtaining the image shown in FIG. 8B. As evident from FIGS. 8A and 8B, it was verified that the bonding interface, as in Example 1, is free of voids having a length of 50 μm or more in a direction parallel to the bonding interface. Further, it was also verified that voids having a length of 10 μm or more were absent in a direction parallel to the bonding interface.

### Vickers Hardness Measurement

Vickers hardness at various positions in a thickness direction (a direction perpendicular to the bonding interface) of the bonded body were measured by the same method as in Example 1. Table 1 shows Vickers hardness HV of the first member composed of the copper alloy and the steel material of the second member. Additionally, FIG. 8C shows a plot of Vickers hardness (HV) at various positions close to the bonding interface. The abscissa axis in FIG. 8C means the distance (mm) from the bonding interface of the bonded body, wherein the plus (+) side corresponds to the second member composed of the steel material and the middle layer, and the minus (−) side corresponds to the first member composed of the copper alloy, respectively.

### Example 9

The bonded body manufactured under the same conditions as in Example 8 was subjected to the precipitation hardening process without carrying out the solution annealing. In the precipitation hardening process, the bonded body was put in a common heat treatment furnace, in which a temperature was raised at a rate of 10° C./min under a nitrogen atmosphere and retained at 450±5° C. for 3 hours, then the bonded body was cooled in the furnace, and taken out after reached room temperature. The heat conductivity of precipitation-hardenable copper alloy of the first member was considered to have been adjusted to 160 W/mK or more by this precipitation hardening process.

### Cross Section Observation

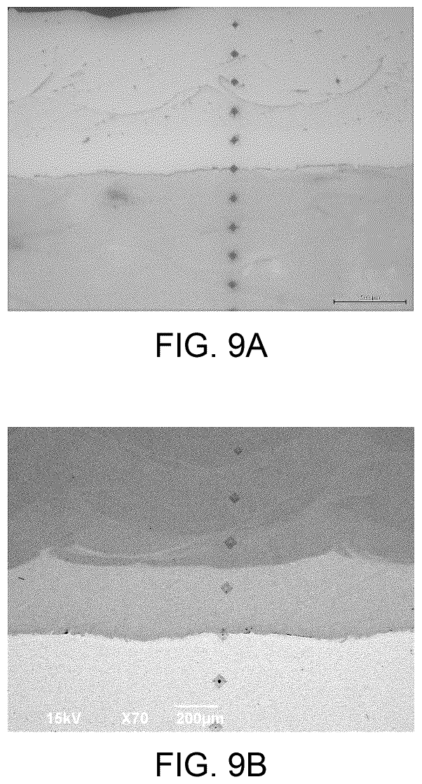

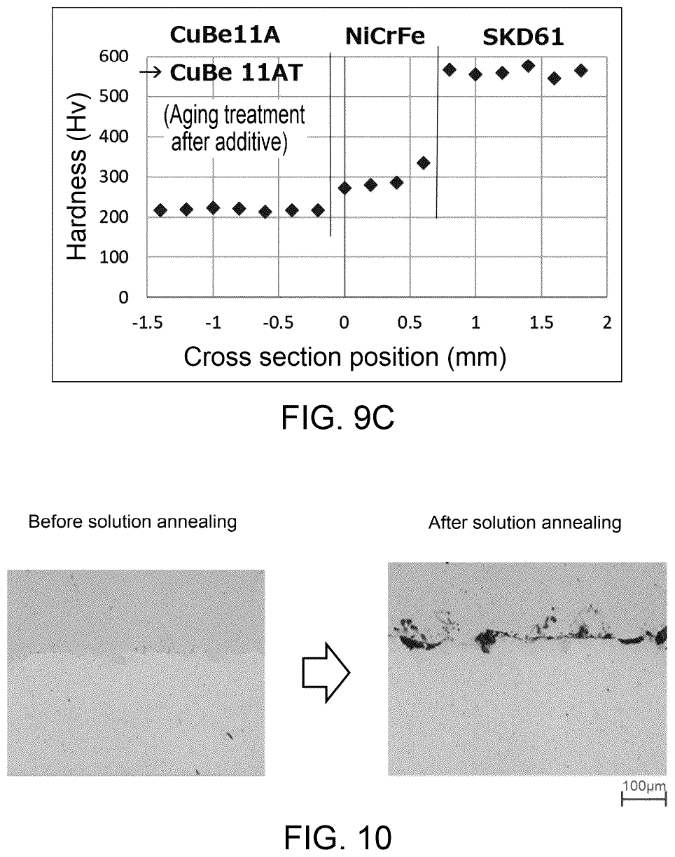

The polished cross section including the bonding interface of the copper alloy and the middle layer and processed by the same method as in Example 1 was observed by an optical microscope at 50× magnification, thereby obtaining the image shown in FIG. 9A. Similarly, the polished cross section including the bonding interface was observed by a scanning electron microscope (SEM) at 100× magnification, thereby obtaining the image shown in FIG. 9B. As evident from FIGS. 9A and 9B, it was verified that the bonding interface, as in Example 1, is free of voids having a length of 50 μm or more in a direction parallel to the bonding interface. Further, it was also verified that voids having a length of 10 μm or more were absent in a direction parallel to the bonding interface.

### Vickers Hardness Measurement

Vickers hardness at various positions in a thickness direction (a direction perpendicular to the bonding interface) of the bonded body were measured by the same method as in Example 1. Table 1 shows Vickers hardness HV of the first member composed of the copper alloy and the steel material of the second member. Additionally, FIG. 9C shows a plot of Vickers hardness (HV) at various positions close to the bonding interface. The abscissa axis in FIG. 9C means the distance (mm) from the bonding interface of the bonded body, wherein the plus (+) side corresponds to the second member composed of the steel material and the middle layer, and the minus (−) side corresponds to the first member composed of the copper alloy, respectively.

TABLE 1

| | | | | | | | | | Second |
|---|---|---|---|---|---|---|---|---|---|
| | | | | | | | | | member |
| | | | | | | First member | | | (Steel |
| | | | | Bonding interface | | (precipitation-hardenable copper alloy) | | | material) |
| | | | | Voids | Voids | | Vickers hardness (HV) | | Vickers |
| | | | Absent/ | having a | having a | | | Throughout | hardness |
| | | | present of | length of | length of | | | entirety | HV of |
| | | | precipita- | 50 μm | 10 μm | | Main part | (including | main part |
| | | | tion | or more in | or more in | | (excluding | main part and | (excluding |
| | | | hardening | direction | direction | | part within | part within | part within |
| | | | process | parallel | parallel | | 1.0 mm | 1.0 mm | 1.0 mm |
| | Bonding | Middle | after | to bonding | to bonding | Material and | from bonding | from bonding | from bonding |
| | method | layer | bonding | interface | interface | temper | interface) | interface) | interface) |
| Ex. 1 | LMD | Absent | Absent | Absent | Partially present | C1720-AT | HV360-440 | HV200-440 | HV530-660 |
| Ex. 2 | LMD | Absent | Present | Absent | Partially present | C1720-AT | HV360-440 | HV360-440 | HV530-660 |
| Ex. 3 | LMD | Present | Absent | Absent | Absent | C1720-AT | HV390-440 | HV120-440 | HV540-590 |
| Ex. 4 | LMD | Present | Present | Absent | Absent | C1720-AT | HV390-440 | HV390-440 | HV540-590 |
| Ex. 5* | TIG | Absent | Absent | Present | Present | C1720-AT | HV140-440 | HV120-440 | HV530-660 |
| | Welding | | | | | | | | |
| Ex. 6* | Laser | Absent | Absent | Present | Present | C1720-AT | HV310-440 | HV205-440 | HV530-660 |
| | welding | | | | | | | | |
| Ex. 7 | LMD | Present | Absent | Absent | Partially present | C1751-AT | HV250-275 | HV160-260 | HV530-660 |
| Ex. 8 | LMD | Present | Absent | Absent | Absent | C1751-A | HV105-120 | HV115-135 | HV530-660 |
| Ex. 9 | LMD | Present | Present | Absent | Absent | C1751-A | HV250-275 | HV250-275 | HV530-660 |

*indicates Comparative Example.
“Bonding interface” means, when a bonded body has a middle layer, the interface of a copper alloy and the middle layer.
Abbreviations in “Material and temper” mean as follows.
C1720-AT is beryllium copper 25 alloy (JIS alloy number C1720) subjected to solution annealing and age treatment.
C1751-AT is beryllium copper 11 alloy (JIS alloy number C1751) subjected to solution annealing and age treatment.
C1751-A is beryllium copper 11 alloy (JIS alloy number C1751) subjected only to solution annealing.

### Examples 10 to 12 (References)

A steel material (the second member) was additively manufactured around the outer circumference of a copper alloy round bar (the first member) by LMD, thereby to manufacture a bonded body. Specifically, using a laser additive manufacturing machine (model name: MU-6300V LASER EX, a product of OKUMA CORPORATION), a steel powder (die steel (JIS G4404 SKD61)) was fed around the round bar (diameter of 10 mm) made of beryllium copper 25 alloy (JIS alloy number C1720) by LMD, thereby to manufacture a bonded body of the copper alloy/the steel material. During this operation, LMD was carried out under the conditions (laser irradiation spot diameter, laser output, feed rate, and interlayer cooling time) shown in Table 2. The Vickers hardness at the copper alloy cross section of the obtained bonded body was measured in the same manner as in Example 1. Table 2 shows the Vickers hardness at the respective positions 0.5 mm, 1.0 mm, and 2.0 mm from the bonding interface of the copper alloy part of the bonded body manufactured in each example. As shown in Table 2, the bonded bodies obtained in Examples 8 and 9 had a Vickers hardness of HV 300 or more. For this reason, during and thereafter the LMD, it is considered that the first member was not retained at a temperature of 400° C. or more for 10 minutes or more, nor retained at a temperature of 500° C. or more for 3 minutes or more.

In Examples 10 to 12, the laser spot diameter, laser output, feed rate, and interlayer cooling time, as the laser machining conditions, were changed thereby to control the temperature conditions, but a method may be carried out in which the LMD conditions such as the gas flow rate and powder feed amount supplied from the process nozzle are changed depending on the heat capacity and thermal history. Further, this method in which the LMD conditions are changed may be carried out simultaneously with a cooling step utilizing a coolant and the like or a step of adding cooling time.

TABLE 2

| | | | | | Vicker hardness (HV) at each | | |
|---|---|---|---|---|---|---|---|
| | | | | | position of bonded body cross | | |
| | LMD Conditions | | | | section (copper alloy part) | | |
| | | Laser | | | Position | Position | Position |
| | | irradiation | | Interlayer | at 0.5 mm | at 1 mm | at 2 mm |
| | Laser | Spot | | cooling | from | from | from |
| | output | diameter | Feed rate | time | bonding | bonding | bonding |
| | (W) | (mm) | (mm/min) | (sec) | interface | interface | interface |
| Ex. 10* | 500 | 1.5 | 600 | 270 | HV170 | HV220 | HV240 |
| Ex. 11* | 300 | 0.6 | 600 | 440 | HV220 | HV340 | HV350 |
| Ex. 12* | 300 | 0.6 | 1200 | 220 | HV310 | HV390 | HV410 |

*indicates Reference Example.

### Example 13 (Comparison)

The LMD bonded body of the copper alloy/the steel material manufactured in Example 1 was subjected to the solution annealing including heating at 800° C. for 1 hour. The polished cross section including the bonding interface was observed by an optical microscope at 250× magnification, thereby obtaining the image shown in FIG. 10. FIG. 10 also shows the cross section image of the bonded body before subjected to the solution annealing. The precipitation-hardenable copper alloy has the property of recovering the strength when the solution annealing at a high temperature and the precipitation hardening near Tm/2 (provided that Tm means a melting point) are carried out. However, as evident from FIG. 10, when the bonded body of the copper alloy/the steel material is subjected to high temperature treatment such as solution annealing, detachment is caused due to the difference in thermal expansion. This result supports the fact described previously that, during and thereafter the LMD, it is preferable that the first member is not retained at a temperature of 400° C. or more for 10 minutes or more, nor retained at a temperature of 500° C. or more for 3 minutes or more.

The bonded body shown in FIG. 10 is the bonded body manufactured by LMD, but the same phenomenon occurs also in the TIG welded bonded body and the laser welded bonded body. Accordingly, it is desirable to avoid softening at the time of bonding. This also applied to a diffusion bonded body, which softens by the heat during bonding.

What is claimed is:

1. A bonded body comprising a first member composed of a precipitation-hardenable copper alloy and a second member including an additively manufactured object made of a steel material bonded to the first member at at least one bonding interface,
wherein the bonded body, when a cross section perpendicular to the bonding interface is observed by a scanning electron microscope (SEM), is free of voids having a length of 50 μm or more at the bonding interface in a direction parallel to the bonding interface.

2. The bonded body according to claim 1, wherein the additively manufactured object made of a steel material is formed by laser metal deposition (LMD).

3. The bonded body according to claim 1, wherein the first member has a Vickers hardness of HV 200 or more at a main part wherein a part within 1.0 mm from the bonding interface in a thickness direction is excluded.

4. The bonded body according to claim 1, wherein the first member has a Vickers hardness of HV 200 or more throughout the entirety including a part within 1.0 mm from the bonding interface in a thickness direction and a main part other than the part within 1.0 the bonding interface.

5. The bonded body according to claim 1, wherein the steel material of the second member has a Vickers hardness of HV 300 or more at a main part wherein a part within 1.0 mm from the bonding interface in a thickness direction is excluded.

6. The bonded body according to claim 1, wherein the precipitation-hardenable copper alloy is at least one alloy selected from the group consisting of chromium copper alloys, chromium zirconium copper alloys, titanium copper alloys, nickel silicon copper alloys, nickel tin copper alloys, and beryllium copper alloys.

7. The bonded body according to claim 6, wherein the precipitation-hardenable copper alloy is a beryllium copper alloy.

8. The bonded body according to claim 1, wherein the steel material is composed of at least one steel selected from the group consisting of die steel (SKD), high speed tool steel (SKH), stainless steel (SUS), and maraging steel.

9. The bonded body according to claim 1, wherein the second member is further provided with a middle layer composed of a heterogeneous metal material on a surface contacting the first member.

10. The bonded body according to claim 9, wherein the heterogeneous metal material composing a middle layer is an alloy comprising Ni as a main component.

11. The bonded body according to claim 9, wherein the heterogeneous metal material composing a middle layer is a nickel-chromium-iron alloy comprising Ni as a main component.

12. The bonded body according to claim 9, wherein the bonded body, when a cross section perpendicular to the bonding interface is observed by a scanning electron microscope (SEM), is free of voids having a length of 10 μm or more at the bonding interface in a direction parallel to the bonding interface.

13. The bonded body according to claim 2, wherein the precipitation-hardenable copper alloy of the first member has a heat conductivity of 160 W/mK or more after precipitation hardening process.

14. The bonded body according to claim 13, wherein the precipitation-hardenable copper alloy is at least one alloy selected from the group consisting of chromium copper alloys, chromium zirconium copper alloys, nickel silicon copper alloys, and beryllium copper alloys.

15. An article comprising the bonded body according to claim 1, wherein the article is selected from a mold and a mold component.

16. A method for manufacturing the bonded body according to claim 2, comprising:
providing a first member composed of a precipitation-hardenable copper alloy which has been subjected to solution annealing, or solution annealing and aging treatment, and
forming, as a second member, an additively manufactured object composed of a steel material by laser metal deposition (LMD) using a powder of the steel material on or above a surface of the first member to obtain a bonded body.

17. The method according to claim 16, further comprising, prior to forming the additively manufactured object composed of a steel material, forming a middle layer on the surface of the first member by LMD using a powder of an alloy comprising a heterogeneous metal other than Cu and Fe as the main component, and
wherein the formation of the additively manufactured object composed of the steel material by the LMD using a powder of the steel material is performed on a surface of the middle layer.

18. The method according to claim 16, wherein the precipitation-hardenable copper alloy has a heat conductivity of 160 W/mK or more after precipitation hardening process,
wherein the precipitation-hardenable copper alloy composing the first member, before forming the second member, has been subjected to solution annealing so as to have a heat conductivity of less than 160 W/mK, and
wherein the precipitation-hardenable copper alloy composing the first member, after forming the second member, is subjected to precipitation hardening process so that a heat conductivity of the precipitation-hardenable copper alloy is adjusted to be 160 W/mK or more.

19. The method according to claim 16, further comprising, after forming the additively manufactured object, retaining the bonded body at a temperature from 280 to 530° C. for from 30 minutes to 5 hours to carry out the precipitation hardening process.

20. The method according to claim 16, wherein, during and after the LMD, the first member is not retained at a temperature of 400° C. or more for 10 minutes or more, and the first member is not retained at a temperature of 500° C. or more for 3 minutes or more.

21. The method according to claim 16, wherein the precipitation-hardenable copper alloy is at least one alloy selected from the group consisting of chromium copper alloys, chromium zirconium copper alloys, titanium copper alloys, nickel silicon copper alloys, nickel tin copper alloys, and beryllium copper alloys.

22. The method according to claim 18, wherein the precipitation-hardenable copper alloy is at least one alloy selected from the group consisting of chromium copper alloys, chromium zirconium copper alloys, nickel silicon copper alloys, and beryllium copper alloys.

23. The method according to claim 16, wherein the precipitation-hardenable copper alloy is a beryllium copper alloy.

24. The method according to claim 16, wherein the steel material is composed of at least one steel selected from the group consisting of die steel (SKD), high speed tool steel (SKH), stainless steel (SUS), and maraging steel.

25. The method according to claim 17, wherein the heterogeneous metal material composing a middle layer is an alloy comprising Ni as a main component.

26. The method according to claim 17, wherein the heterogeneous metal material composing a middle layer is a nickel-chromium-iron alloy comprising Ni as a main component.
